(19) United States
(12) Patent Application Publication
(10) Pub. No.: US 2018/0218386 A1
(43) Pub. Date: Aug. 2, 2018

(54) METHOD AND SYSTEM FOR EVALUATING USER-ACTIVITIES IN A DISTRIBUTION CHANNEL

(71) Applicant: Wipro Limited, Bangalore (IN)

(72) Inventor: Jayanta Kumar MAL, Bangalore (IN)

(73) Assignee: Wipro Limited

(21) Appl. No.: 15/459,137

(22) Filed: Mar. 15, 2017

(30) Foreign Application Priority Data
Jan. 31, 2017 (IN) 201741003643

(51) Int. Cl. G06Q 30/02

(52) U.S. Cl. CPC G06Q 30/0214

(57) ABSTRACT

Systems and methods for evaluating user-activities in a distribution channel are described. The system generates hierarchical structure of the distribution channel. The hierarchical structure includes plurality of nodes indicative of distribution points of the distribution channel. With each node, one or more users and inducement plan is associated. The inducement plan includes one or more eligibility criteria. The system stores the inducement plan along with the eligibility criteria in inducement plan database. Further, multi-dimensional model is defined corresponding to the hierarchical structure. The multi-dimensional model includes one or more dimensions and activity parameters associated with the one or more dimensions. The system monitors user activities in relation to the one or more activity parameters. Further, activity data associated with the activities is stored in user-activity database. The system performs data processing upon the user-activity database and the inducement plan database for evaluating the user activities.

### TECHNICAL FIELD

The present disclosure relates in general to data processing. More particularly, but not exclusively, the present disclosure discloses a method and system for processing data for evaluating user-activities in a distribution channel.

### BACKGROUND

With the growth of technology, the amount of data has exponentially increased in recent years. The increase in the volume of the data comes with a challenge of efficient processing of the data for deriving useful information. The useful information may be related to various sectors like telecommunication sector, healthcare sector, automobile sector and the like. Each of these sectors is linked with multiple channels which is required for executing different functions. Each channel has its defined roles and responsibilities to achieve common objective.

For example, in the telecommunication sector, distribution channels are provided for facilitating services and products to subscribers or end users. While executing the roles and responsibilities, huge amount of data is generated by users involved in activity of facilitating the services and the products to the end users. Handling such huge data is a challenging task not only because of its volume, but it's also because it is in a non-organized manner.

### SUMMARY

The present disclosure relates to a method of evaluating user-activities in a distribution channel. The method comprises the steps of generating a hierarchical structure of the distribution channel. The hierarchical structure comprises a plurality of nodes indicative of distribution points of the distribution channel. With each node, of the plurality of nodes, one or more users and at least one inducement plan is associated therewith. Further, the at least one inducement plan comprises one or more eligibility criteria. The method further comprises storing the at least one inducement plan along with the corresponding one or more eligibility criteria in an inducement plan database such that the at least one inducement plan is linked with corresponding node of the plurality of nodes. Further, the method comprises a step of defining a multi-dimensional model corresponding to the hierarchical structure. The multi-dimensional model comprises one or more dimensions. Further, each of the one or more dimensions are associated with one or more activity parameters. The method further comprises a step of monitoring activities of the one or more users at each of the plurality of nodes of the hierarchical structure for a predefined time-period. The activities are monitored in relation to the one or more activity parameters. Further, the method comprises storing activity data associated with the activities of the one or more users in a user-activity database such that the activity data is linked with corresponding node of the plurality of nodes. The method further comprises evaluating the activity data of the one or more users to identify at least one user from the one or more users for distributing the at least one inducement plan. Further, the evaluation is based on processing of the inducement plan database and the user-activity database.

Further, the present disclosure relates to an evaluating system for evaluating user-activities in a distribution channel. The evaluating system comprises a processor and a memory communicatively coupled to the processor. The memory stores processor-executable instructions, which, on execution, causes the processor to perform one or more operations comprising generating a hierarchical structure of the distribution channel. The hierarchical structure comprises a plurality of nodes indicative of distribution points of the distribution channel. Further, with each node, of the plurality of nodes, one or more users and at least one inducement plan is associated therewith. Further, the at least one inducement plan comprises one or more eligibility criteria. The system further stores the at least one inducement plan along with the corresponding one or more eligibility criteria in an inducement plan database such that the at least one inducement plan is linked with corresponding node of the plurality of nodes. Further, the system defines a multi-dimensional model corresponding to the hierarchical structure. The multi-dimensional model comprises one or more dimensions. Further, each of the one or more dimensions are associated with one or more activity parameters. The system further monitors activities of the one or more users at each of the plurality of nodes of the hierarchical structure for a predefined time-period. The activities are monitored in relation to the one or more activity parameters. Further, the system stores activity data associated with the activities of the one or more users in a user-activity database such that the activity data is linked with corresponding node of the plurality of nodes. The system further evaluates the activity data of the one or more users to identify at least one user from the one or more users for distributing the at least one inducement plan. Further, the evaluation is based on processing of the inducement plan database and the user-activity database.

Further, the present disclosure relates to a non-transitory computer-readable medium storing computer-executable instructions for evaluating user-activities in a distribution channel. In one example, the stored instructions, when executed by a processor, cause the processor to perform operations that comprise generating a hierarchical structure of the distribution channel. The hierarchical structure comprises a plurality of nodes indicative of distribution points of the distribution channel. Further, with each node, of the plurality of nodes, one or more users and at least one inducement plan is associated therewith. Further, the at least one inducement plan comprises one or more eligibility criteria. The operations further comprise storing the at least one inducement plan along with the corresponding one or more eligibility criteria in an inducement plan database such that the at least one inducement plan is linked with corresponding node of the plurality of nodes. Further, the operation comprise defining a multi-dimensional model corresponding to the hierarchical structure. The multi-dimensional model comprises one or more dimensions. Further, each of the one or more dimensions are associated with one or more activity parameters. The operations further comprise monitoring activities of the one or more users at each of the plurality of nodes of the hierarchical structure for a predefined time-period. The activities are monitored in relation to the one or more activity parameters. Further, the operations comprise storing activity data associated with the activities of the one or more users in a user-activity database such that the activity data is linked with corresponding node of the plurality of nodes. The operations further comprise evaluating the activity data of the one or more users to identify at least one user from the one or more users for distributing the at least one inducement plan. Further, the evaluation is based on processing of the inducement plan database and the user-activity database.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 shows an exemplary environment illustrating an evaluating system for evaluating user-activities in a distribution channel in accordance with some embodiments of the present disclosure;

FIG. 2 shows a detailed block diagram illustrating the evaluating system in accordance with some embodiments of the present disclosure;

FIG. 3 shows a flowchart illustrating a method of evaluating user-activities in a distribution channel in accordance with some embodiments of the present disclosure; and

FIG. 4 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, “includes”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The present disclosure relates to a method and an evaluating system (alternatively also referred as “system”) for evaluating user-activities in a distribution channel. Although, the method for evaluating user-activities is described in conjunction with a server, the said method can also be implemented in various computing systems/devices, other than the server. In an environment like a distribution channel, involvement of number of users is obvious. The number of users are involved in performing various activities which are related to their roles and responsibilities. Further, the roles and responsibilities depend upon their location in the distribution channel. To keep the users motivated, there may be various inducement plans associated with each distribution point of the distribution channel. The inducement plans may be considered as reward given to the users based on their performance. However, before rewarding the users, a technical challenge of monitoring activities of the users at different levels and handling huge data generated during the performance of the such activities has to be overcome.

Considering an example of a telecom sector, the distribution channel may include various distribution points like distributors/franchises, local sales point, and Point of Sale (POS). It must be understood by a person skilled in art that there may be n number of distribution points associated with the distribution channel. At each of the distribution point, one or more users may be associated to perform various task or activities. The activities performed at the distributors/franchises distribution point may include, for example, allocating Start-Up Kits (SUKs) to local sales point, distributing recharge vouchers to the local sales point and the like.

Since, the distribution follows a channel, the SUKs and the recharge vouchers received from the distributors/franchises may be further forwarded or distributed, by the local sales point, to the POS (another distributing point) which interacts with subscribers. Such forwarding or distributing may be related to the activities of one or more users located at the local sales point. It must be understood to a person skilled in art that there may be other types of telecom related products (e.g., special data vouchers or voice vouchers and the like) which may be also distributed from the distributors/franchises to the local sales point and further to the POS.

When the start-up kits or the recharge vouchers reaches at the POS, the next activity performed by users located at the POS may include, for example, activating new connections, Mobile Number Portability (MNP) activations, and selling of the recharge vouchers to the subscribers. Apart from the activities at the different distribution points, the system may also monitor the activity of the subscribers, for example, data usage or voice usage or text usage which may be collectively called as Call Data Records (CDR). There may be millions or billions of the subscribers actively using or consuming the telecom related products or services provided by telecom operators, and hence the CDR increases exponentially. Thus, all the activities performed at various distribution points of the distribution channel as well as the CDR contributes in generation of huge amount of data.

The activities need to be monitored so that the users of the distribution channel may be rewarded for their performance based on the inducement plans. Monitoring activities means monitoring huge amount of activity data related to the activities of the users. The system, for monitoring the activities of the users, may generate a multi-dimensional model having number of activity parameters. In relation to the activity parameters, the activities of the users may be monitored and corresponding activity data may be stored in database of the system. Since the data is huge, the system may perform big data analysis or big data processing upon the stored data to fetch out meaningful information for evaluating the activities of the users.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

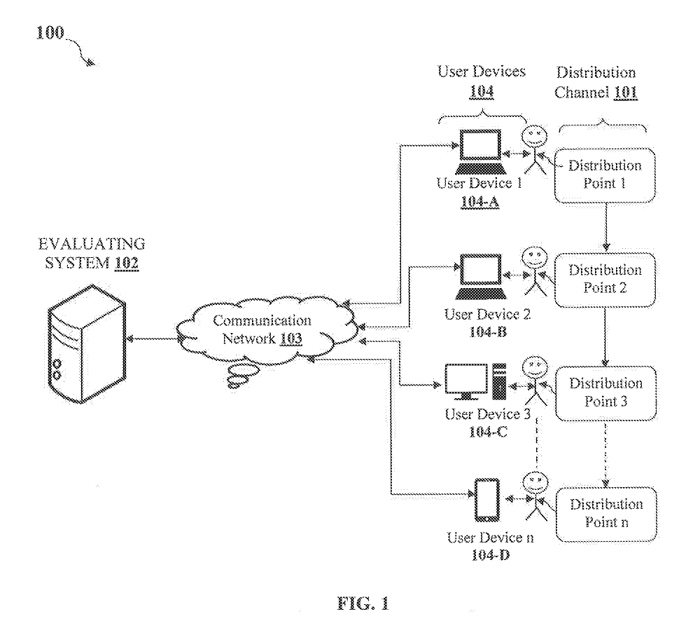

FIG. 1 shows an exemplary environment illustrating an evaluating system for evaluating user-activities in a distribution channel.

The environment 100 includes a distribution channel 101, the evaluating system 102, communication network 103, and user devices 104. The distribution channel 101 comprises n number of distribution points i.e., Distribution Point 1, Distribution Point 2, Distribution Point 3, Distribution Point n. Further, the communication network 103 may be a wired or a wireless network for establishing a communication between the evaluating system 102 and the user devices 104. Further, the user devices 104 may include n number of user devices (User Device 1, User Device 2, User Device 3, User Device n) associated with the plurality of users located at the distribution points of the distribution channel 101.

The evaluating system 102 may generate the hierarchical structure of the distribution channel 101 so that all the distribution points of the distribution channel get structured. The structured view of the distribution points helps the evaluating system 102 understand importance of the distribution points as well as relationship amongst the distribution points in the distribution channel 101. It also helps the evaluating system 102 to navigate from one distribution point to another distribution point (i.e., from one node to another node of the hierarchical structure) easily and efficiently for data processing. This helps in improving the functioning of the evaluating system 102 while evaluating the user-activities.

Further, the evaluating system 102 monitors the activities of the one or more users by receiving input from the user devices 104. For example, whenever a user at the Distribution Point 3 activates a new connection for the subscriber, the User Device 3 may automatically send the activation information (which indicates activity data or user-activity data) to the evaluating system 102. In response, the evaluating system 102 may update its databases for processing the activity data. This way, the evaluating system 102 may monitor the activities by receiving the activity data from the plurality of user devices 104 whenever the users perform any activity. Further, the activity data stored in the database is processed for evaluating the user-activities and rewarding them accordingly for their performance.

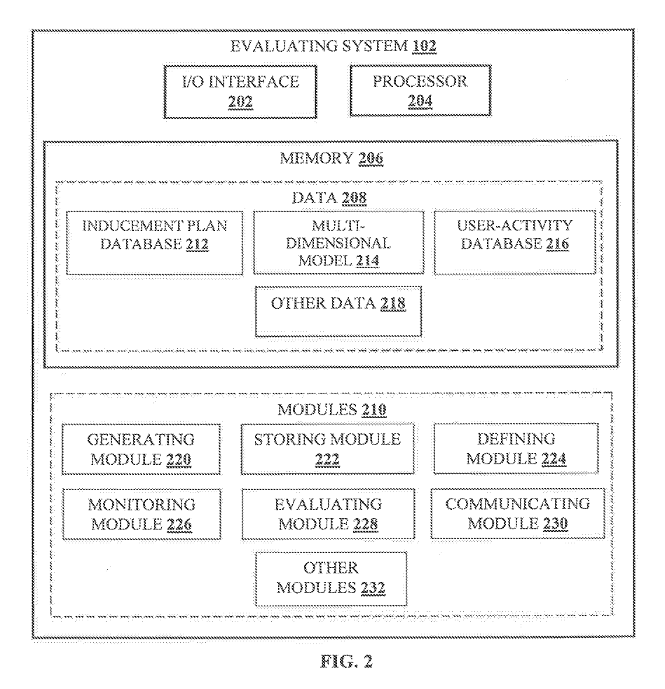

FIG. 2 shows a detailed block diagram illustrating the evaluating system in accordance with some embodiments of the present disclosure.

The evaluating system 102 comprises an I/O interface 202, a processor 204, and a memory 206. The I/O interface 202 is configured to receive input (activity data) from plurality of user devices 104 located at various distribution points of the distribution channel 101. The memory 206 is communicatively coupled to the processor 204. The processor 204 is configured to perform one or more functions of the evaluating system 102 for evaluating user-activities in a distribution channel 101. In one implementation, the evaluating system 102 comprises data 208 and modules 210 for performing various operations in accordance with the embodiments of the present disclosure. In an embodiment, the data 208 may include, without limitation, inducement plan database 212, multi-dimensional model 214, user-activity database 216, and other data 218.

In one embodiment, the data 208 may be stored within the memory 206 in the form of various data structures. Additionally, the aforementioned data 208 can be organized using data models, such as relational or hierarchical data models. The other data 218 may store data, including temporary data and temporary files, generated by modules 210 for performing the various functions of the evaluating system 102.

In an embodiment, the data 208 may be processed by one or more modules 210. In one implementation, the one or more modules 210 may also be stored as a part of the processor 204. In an example, the one or more modules 210 may be communicatively coupled to the processor 204 for performing one or more functions of the evaluating system 102.

In one implementation, the one or more modules 210 may include, without limitation, a generating module 220, a storing module 222, a defining module 224, a monitoring module 226, an evaluating module 228, a communicating module 230, and other modules 232. As used herein, the term module refers to an application specific integrated circuit (ASIC), an electronic circuit, a processor (shared, dedicated, or group) and memory that execute one or more software or firmware programs, a combinational logic circuit, and/or other suitable components that provide the described functionality.

In an embodiment, the generating module 220 may generate a hierarchical structure of the distribution channel 101. Since the distribution channel 101 may include random number of distribution points, generating of the hierarchical structure helps the evaluating system 102 understand about the overall structure of the distribution channel 101. The hierarchical structure is generated in such a manner that a plurality of nodes, of the hierarchical structure, indicates the distribution points of the distribution channel 101. This way, the generating module 220 provides a consolidated view of the distribution channel 101 to the evaluating system 102 which helps in efficient processing of data corresponding to the distribution channel 101.

Since, one of an application of the present disclosure is to reward users involved in the distribution channel 101 based on their performance, an inducement plan is needed to be associated with each distribution point of the distribution channel 101. Thus, with each node, of the plurality of nodes of the hierarchical structure, one or more users and at least one inducement plan is associated. The at least one inducement plan may include one or more eligibility criteria which serves as a parameter for evaluating the activities of the one or more users.

In an embodiment, the storing module 222 of the evaluating system 102 may store the inducement plans along with their corresponding one or more eligibility criteria in an inducement plan database 212 in such a manner that each inducement plan is linked with corresponding node of the plurality of nodes of the hierarchical structure. The inducement plan database 212 may be located at particular segment of the memory 206 accessible by the evaluating system 102. An example of the inducement plans stored in the inducement plan database 212, considering three nodes Node 1, Node 2 and Node 3, is shown below in table 1.

TABLE 1
Example of the inducement plans stored in the inducement plan database

| Nodes | Users | Inducement Plan (IP) | Eligibility Criteria (C) |
|---|---|---|---|
| Node 1 | User 1 | IP 1 | C1 and C2 |
| Node 2 | User 2 | IP 2 | C3 |
| Node 3 | User 3 | IP 3 | C4 and C5 |

From the above table 1, it can be observed that there are two eligibility criteria (C1 and C2) to be analyzed for rewarding IP 1 (inducement plan) to the “User 1” located at Node 1. Similarly, there is only one eligibility criteria (C3) to be analyzed for rewarding IP 2 (inducement plan) to the “User 2” located at Node 2. Similarly, there are two eligibility criteria (C4 and C5) to be analyzed for rewarding IP 3 (inducement plan) to the “User 3” located at Node 3. Further, the inducement plan is also associated with an inducement period indicating validity of the inducement plan.

Referring back to the telecom sector example, if the “User 3” located at Node 3 (for example, POS) is able to activate more than 10 new connections (i.e., Criteria C4) and also able to sell the recharge vouchers worth Rs. 2000 to the subscribers (i.e., Criteria C5) within the inducement period of “IP 3”, then the “User 3” may be eligible for receiving the inducement plan “IP 3”. It may be observed from the above that for satisfying the eligibility criteria, several activities are involved from user's end at different variations like type of activity, volume of the activity, direction of the activity and the like. Therefore, to adequately capture the user activities, each perspective of the user activity is to be considered.

In an embodiment, the defining module 224 of the evaluating system 102 may define a multi-dimensional model 214 corresponding to the hierarchical structure for adequately capturing the activities of the users located at each node or distribution channel from different perspectives. The multi-dimensional model 214 may include one or more dimensions, for example, a first-dimension, a second-dimension, and a third-dimension. Each of the first, second and third-dimension are associated with one or more activity parameters used for monitoring the activities of the users.

In the first-dimension, the one or more activity parameters include transaction from one node to another node of the plurality of nodes of the hierarchical structure. In other words, the direction of the activities of the user may be monitored through the first-dimension. For example, a user at distributor's/franchisee's end (Node 1) distributes/allocates 30 Start-Up Kits (SUKs) to local sales point (Node 2). This shows that the direction of the transaction is from Node 1 to Node 2.

In the second-dimension, the one or more activity parameters include type of the transaction at each of the plurality of nodes. For example, the activities like activation of new connections, Mobile Number Portability (MNP) activations, sales of the recharge vouchers and the like are captured using the second-dimension. Further, the activities of subscribers like voice usage or data usage are also captured through the second-dimension.

Further, in the third-dimension, the one or more activity parameters include volume of the transaction at each of the plurality of nodes. For example, an amount (i.e., volume) of data recharge or voice recharge done by the user at Node 3. In another example, a total number (i.e., volume) of the SUKs allocated from the distributor/franchisee (Node 1) to the local sales point (Node 2).

Thus, considering the above three dimensions of the multi-dimensional model 214, the monitoring module 226 of the evaluating system 102 may monitor the activities of the one or more users at each of the plurality of nodes of the hierarchical structure for a predefined time-period. In other words, the activities are monitored in relation to the one or more activity parameters of the three dimensions of the multi-dimensional model 214. This ensures that activities of the users are sufficiently monitored from each perspective.

The activities are monitored by receiving input from the user devices 104 associated with the users located at the distribution points. Here the “input” refers to “activity data” of the users. For example, as soon as one of the user at distributor's/franchisee's end (Node 1) distributes/allocates 20 start-up kits (SUKs) to the local sales point (Node 2), the “User Device 1 104-A” transmits the allocation information of the SUKs (which indicates the activity data of the user) to the evaluating system 102. Similarly, as soon as one of the user at the POS (Node 3) activates a new connection or performs recharge of a Rs. 100 voucher, the “User Device 3 104-C” transmits the new connection activation information as well as recharge information (which indicates the activity data of the user) to the evaluating system 102. This way, the monitoring module 226 monitors all the activities of the users through interaction between the user devices 104 and the evaluating system 102.

In an embodiment, the storing module 222 of the evaluating system 102 may store the above explained activity data associated with the activities of the one or more users in a user-activity database 216. The activity data may be stored in such a manner that the activity data is linked with corresponding node of the plurality of nodes of the hierarchical structure. The user-activity database 216 may be located at a particular segment of the memory 206 accessible by the evaluating system 102. An example of the activity data stored in the user-activity database 216, considering three nodes N1, N2 and N3, is shown below in table 2.

TABLE 2
Example of the activity data stored in the user-activity database.

| Nodes | Users | Activity Data |
|---|---|---|
| Node 1 | User 1 | A1 - Allocating 20 start-up kits (SUKs) to local sales |
| | | point |
| Node 2 | User 2 | A2 - Sales of recharge vouchers worth Rs. 5K |
| Node 3 | User 3 | A3 - Activation of a new connection |

From the above table 2, it can be observed that the activity data “A1” indicates the allocation of 20 start-up kits (SUKs) from User 1 (located at the distributor/franchisee end i.e., Node 1) to local sales point (Node 2). Similarly, it can also be observed that activity data “A3” indicates activation of a new connection from User 3 (located at the POS i.e., Node 3) to the subscriber or the end user.

Now, both the databases i.e., inducement plan database 212 and the user-activity database 216 are populated with the required data for processing. However, the amount of data in both the databases (212, 216) is so huge that traditional data processing techniques may not be sufficient for processing the data. Thus, the present disclosure may apply a big data processing for evaluating the data stored in the both the databases (212, 216).

For evaluating the data, the evaluating module 228 of the evaluating system 102 may access the segments of the memory, in which, the both the databases (212, 216) are stored. According to embodiments, the evaluating module 228 may process, by applying the big data analysis, inducement plan database 212 and the user-activity database 216 such that the activity data (from the user-activity database 216) is compared with the one or more eligibility criteria (from the inducement plan database 212). Based on the comparison, the evaluating module 228 may evaluate the activity data of the one or more users to identify at least one user from the one or more users for distributing the at least one inducement plan. Further, the at least one user identified for distributing the inducement plan is associated with the node that corresponds to the identified user, based on the evaluation.

For example, if during the data processing, it is determined that User 3 has activated more than 10 new connections within the inducement period, the evaluating module 228 identifies “User 3” eligible for distributing the inducement plan. Once the users are identified, the communicating module 230 of the evaluating system 102 may communicate the inducement plan to that identified user.

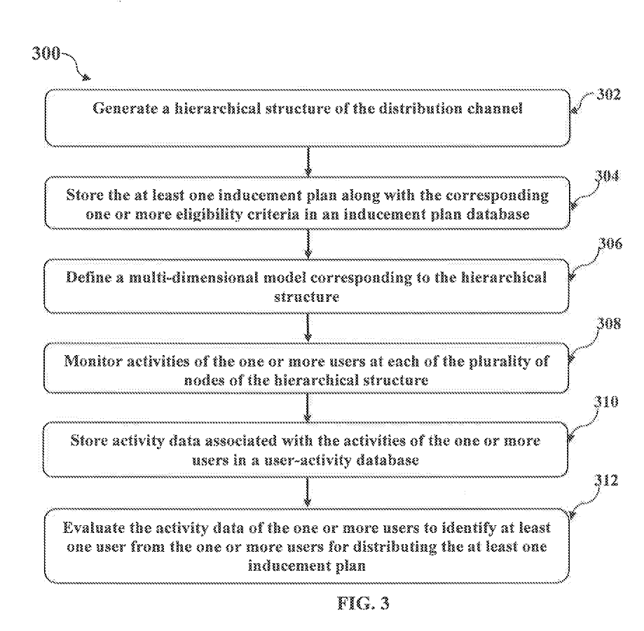

FIG. 3 shows a flowchart illustrating a method of evaluating user-activities in a distribution channel with some embodiments of the present disclosure.

As illustrated in FIG. 3, the method 300 comprises one or more blocks for evaluating user-activities in a distribution channel using an evaluating system 102. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 302, the evaluating system 102 generates a hierarchical structure of the distribution channel. The hierarchical structure includes a plurality of nodes indicative of distribution points of the distribution channel 101. Further, with each node, of the plurality of nodes, one or more users and at least one inducement plan may be associated therewith. Further, the at least one inducement plan includes one or more eligibility criteria.

At block 304, the evaluating system 102 stores the at least one inducement plan along with the corresponding one or more eligibility criteria in an inducement plan database 212 such that the at least one inducement plan is linked with corresponding node of the plurality of nodes.

At block 306, the evaluating system 102 defines a multi-dimensional model 214 corresponding to the hierarchical structure. The multi-dimensional model 214 includes one or more dimensions. Further, each of the one or more dimensions are associated with one or more activity parameters.

At block 308, the evaluating system 102 monitors activities of the one or more users at each of the plurality of nodes of the hierarchical structure for a predefined time-period. The activities are monitored in relation to the one or more activity parameters.

At block 310, the evaluating system 102 stores activity data associated with the activities of the one or more users in a user-activity database 216 such that the activity data is linked with corresponding node of the plurality of nodes.

At block 312, the evaluating system 102 evaluates the activity data of the one or more users to identify at least one user from the one or more users for distributing the at least one inducement plan. Further, the evaluation is based on processing of the inducement plan database 212 and the user-activity database 216.

### Computer System

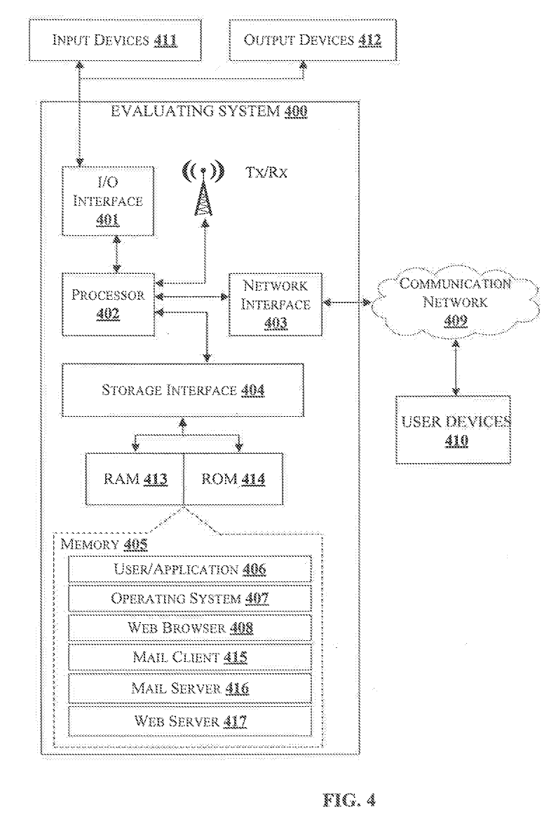

FIG. 4 illustrates a block diagram of an exemplary computer system 400 for implementing embodiments consistent with the present invention. In an embodiment, the computer system 400 can be the evaluating system 102 which is used for evaluating user-activities in a distribution channel. According to an embodiment, the computer system 400 may receive input pertaining to activities of the users from user devices 410 The computer system 400 may comprise a central processing unit (“CPU” or “processor”) 402. The processor 402 may comprise at least one data processor for executing program components for executing user- or system-generated business processes. The processor 402 may include specialized processing units such as integrated system (bus) controllers, memory management control units, floating point units, graphics processing units, digital signal processing units, etc.

The processor 402 may be disposed in communication with one or more input/output (I/O) devices (411 and 412) via 1/O interface 401. The I/O interface 401 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc.

Using the I/O interface 401, the computer system 400 may communicate with one or more I/O devices (411 and 412).

In some embodiments, the processor 402 may be disposed in communication with a communication network 409 via a network interface 403. The network interface 403 may communicate with the communication network 409. The network interface 403 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. The communication network 409 can be implemented as one of the different types of networks, such as intranet or Local Area Network (LAN) and such within the organization. The communication network 409 may either be a dedicated network or a shared network, which represents an association of the different types of networks that use a variety of protocols, for example, Hypertext Transfer Protocol (HTTP), Transmission Control Protocol/Internet Protocol (ICP/IP), Wireless Application Protocol (WAP), etc., to communicate with each other. Further, the communication network 409 may include a variety of network devices, including routers, bridges, servers, computing devices, storage devices, etc.

In some embodiments, the processor 402 may be disposed in communication with a memory 405 (e.g., RAM 413, ROM 414, etc. as shown in FIG. 4) via a storage interface 404. The storage interface 404 may connect to memory 405 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, user/application data 406, an operating system 407, web browser 408 etc. In some embodiments, computer system 400 may store user/application data 406, such as the data, variables, records, etc. as described in this invention. Such databases may be implemented as fault-tolerant, relational, scalable, secure databases such as Oracle or Sybase.

The operating system 407 may facilitate resource management and operation of the computer system 400. Examples of operating systems include, without limitation, Apple Macintosh OS X, UNIX, Unix-like system distributions (e.g., Berkeley Software Distribution (BSD), FreeBSD, Net BSI), Open BSD, etc.), Linux distributions (e.g., Red Hat, Ubuntu, K-Ubuntu, etc.), International Business Machines (IBM) OS/2, Microsoft Windows (XP, Vista/7/8, etc.), Apple iOS, Google Android, Blackberry Operating System (OS), or the like. I/O interface 401 may facilitate display, execution, interaction, manipulation, or operation of program components through textual or graphical facilities. For example, I/O interface may provide computer interaction interface elements on a display system operatively connected to the computer system 400, such as cursors, icons, check boxes, menus, windows, widgets, etc. Graphical User Interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, JavaScript, AJAX, HTML, Adobe Flash, etc.), or the like.

In some embodiments, the computer system 400 may implement a web browser 408 stored program component. The web browser may be a hypertext viewing application, such as Microsoft Internet Explorer, Google Chrome, Mozilla Firefox, Apple Safari, etc. Secure web browsing may be provided using Secure Hypertext Transport Protocol (HTTPS) secure sockets layer (SSL), Transport Layer Security (TLS), etc. Web browsers may utilize facilities such as AJAX, DI-HTML, Adobe Flash, JavaScript, Java, Application Programming Interfaces (APIs), etc. In some embodiments, the computer system 400 may implement a mail server stored program component. The mail server may be an Internet mail server such as Microsoft Exchange, or the like. The mail server may utilize facilities such as Active Server Pages (ASP), ActiveX, American National Standards Institute (ANSI) C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 400 may implement a mail client stored program component. The mail client may be a mail viewing application, such as Apple Mail, Microsoft Entourage, Microsoft Outlook, Mozilla Thunderbird, and the like.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

Advantages of the Embodiment of the Resent Disclosure are Illustrated Herein.

In an embodiment, the present disclosure provides a method of efficiently processing the huge amount of data for evaluating user activities.

In an embodiment, the method of present disclosure consolidates the distribution channel by generating the hierarchical structure to help the evaluating system to understand structure and relationship between the distribution points of the distribution channel.

In an embodiment, the present disclosure keeps the users motivated by communicating the inducement plan based on their performance.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference Number | Description |
|---|---|
| 100 | ENVIRONMENT |
| 101 | DISTRIBUTION CHANNEL |
| 102 | EVALUATING SYSTEM |
| 103 | COMMUNICATION NETWORK |
| 104 | USER DEVICES |
| 104-A | USER DEVICE 1 |
| 104-B | USER DEVICE 2 |
| 104-C | USER DEVICE 3 |
| 104-D | USER DEVICE N |
| 202 | I/O INTERFACE |
| 204 | PROCESSOR |
| 206 | MEMORY |
| 208 | DATA |
| 210 | MODULES |
| 212 | INDUCEMENT PLAN DATABASE |
| 214 | MULTI-DIMENSIONAL MODEL |
| 216 | USER-ACTIVITY DATABASE |
| 218 | OTHER DATA |
| 220 | GENERATING MODULE |
| 222 | STORING MODULE |
| 224 | DEFINING MODULE |
| 226 | MONITORING MODULE |
| 228 | EVALUATING MODULE |
| 230 | COMMUNICATING MODULE |
| 232 | OTHER MODULES |

1. A method of evaluating user-activities in a distribution channel, the method comprising:
generating, by an evaluating system, a hierarchical structure of the distribution channel, wherein the hierarchical structure comprises a plurality of nodes indicative of distribution points of the distribution channel, and wherein with each node, of the plurality of nodes, one or more users and at least one inducement plan is associated therewith, and wherein the at least one inducement plan comprises one or more eligibility criteria;
storing, by the evaluating system, the at least one inducement plan along with the corresponding one or more eligibility criteria in an inducement plan database such that the at least one inducement plan is linked with corresponding node of the plurality of nodes;
defining, by the evaluating system, a multi-dimensional model corresponding to the hierarchical structure, wherein the multi-dimensional model comprises one or more dimensions, and wherein each of the one or more dimensions are associated with one or more activity parameters;
monitoring, by the evaluating system, activities of the one or more users at each of the plurality of nodes of the hierarchical structure for a predefined time-period, wherein the activities are monitored in relation to the one or more activity parameters;
storing, by the evaluating system, activity data associated with the activities of the one or more users in a user-activity database such that the activity data is linked with corresponding node of the plurality of nodes; and
evaluating, by the evaluating system, the activity data of the one or more users to identify at least one user from the one or more users for distributing the at least one inducement plan, wherein evaluation is based on processing of the inducement plan database and the user-activity database.

2. The method as claimed in claim 1, wherein the processing comprises comparison of the activity data from the user-activity database with the one or more eligibility criteria from the inducement plan database.

3. The method as claimed in claim 1, wherein the at least one user identified for distributing the inducement plan is associated with the node that corresponds to the identified user, based on the evaluation.

4. The method as claimed in claim 1, further comprising communicating, by the evaluating system, the inducement plan to the at least one user.

5. The method as claimed in claim 1, wherein the one or more dimensions comprises a first-dimension, a second-dimension and a third-dimension.

6. The method as claimed in claim 5, wherein:
in the first-dimension, the one or more activity parameters comprises transaction from one node to another node of the plurality of nodes,
in the second-dimension, the one or more activity parameters comprises type of the transaction at each of the plurality of nodes, and
in the third-dimension, the one or more activity parameters comprises volume of the transaction at each of the plurality of nodes.

7. The method as claimed in claim 1, wherein the at least one inducement plan is associated with an inducement period indicating validity of the at least one inducement plan.

8. The method as claimed in claim 1, wherein the activities of the one or more users are monitored by receiving input from one or more user-devices, of the one or more users, associated with each of the plurality of nodes.

9. An evaluating system for evaluating user-activities in a distribution channel, the system comprising:
a processor; and
a memory communicatively coupled to the processor, wherein the memory stores processor-executable instructions, which, on execution, causes the processor to:
generate a hierarchical structure of the distribution channel, wherein the hierarchical structure comprises a plurality of nodes indicative of distribution points of the distribution channel, and wherein with each node, of the plurality of nodes, one or more users and at least one inducement plan is associated therewith, and wherein the at least one inducement plan comprises one or more eligibility criteria;
store the at least one inducement plan along with the corresponding one or more eligibility criteria in an inducement plan database such that the at least one inducement plan is linked with corresponding node of the plurality of nodes;
define a multi-dimensional model corresponding to the hierarchical structure, wherein the multi-dimensional model comprises one or more dimensions, and wherein each of the one or more dimensions are associated with one or more activity parameters;
monitor activities of the one or more users at each of the plurality of nodes of the hierarchical structure for a predefined time-period, wherein the activities are monitored in relation to the one or more activity parameters;
store activity data associated with the activities of the one or more users in a user-activity database such that the activity data is linked with corresponding node of the plurality of nodes; and
evaluate the activity data of the one or more users to identify at least one user from the one or more users for distributing the at least one inducement plan, wherein evaluation is based on processing of the inducement plan database and the user-activity database.

10. The evaluating system as claimed in claim 9, the processing comprises comparison of the activity data from the user-activity database with the one or more eligibility criteria from the inducement plan database.

11. The evaluating system as claimed in claim 9, wherein the at least one user identified for distributing the inducement plan is associated with the node that corresponds to the identified user, based on the evaluation.

12. The evaluating system as claimed in claim 9, wherein the processor is further configured to communicate the inducement plan to the at least one user.

13. The evaluating system as claimed in claim 9, wherein the one or more dimensions comprises a first-dimension, a second-dimension and a third-dimension.

14. The evaluating system as claimed in claim 13, wherein:
in the first-dimension, the one or more activity parameters comprises transaction from one node to another node of the plurality of nodes,
in the second-dimension, the one or more activity parameters comprises type of the transaction at each of the plurality of nodes, and
in the third-dimension, the one or more activity parameters comprises volume of the transaction at each of the plurality of nodes.

15. The evaluating system as claimed in claim 9, wherein the at least one inducement plan is associated with an inducement period indicating validity of the at least one inducement plan.

16. The evaluating system as claimed in claim 9, wherein the activities of the one or more users are monitored by receiving input from one or more user-devices, of the one or more users, associated with each of the plurality of nodes.

17. A non-transitory computer-readable medium storing instructions for evaluating user-activities in a distribution channel, wherein upon execution of the instructions by one or more processors, the processors perform operations comprising:
generating a hierarchical structure of the distribution channel, wherein the hierarchical structure comprises a plurality of nodes indicative of distribution points of the distribution channel, and wherein with each node, of the plurality of nodes, one or more users and at least one inducement plan is associated therewith, and wherein the at least one inducement plan comprises one or more eligibility criteria;
storing the at least one inducement plan along with the corresponding one or more eligibility criteria in an inducement plan database such that the at least one inducement plan is linked with corresponding node of the plurality of nodes;
defining a multi-dimensional model corresponding to the hierarchical structure, wherein the multi-dimensional model comprises one or more dimensions, and wherein each of the one or more dimensions are associated with one or more activity parameters;
monitoring activities of the one or more users at each of the plurality of nodes of the hierarchical structure for a predefined time-period, wherein the activities are monitored in relation to the one or more activity parameters;
storing activity data associated with the activities of the one or more users in a user-activity database such that the activity data is linked with corresponding node of the plurality of nodes; and evaluating, by the evaluating system, the activity data of the one or more users to identify at least one user from the one or more users for distributing the at least one inducement plan, wherein evaluation is based on processing of the inducement plan database and the user-activity database.
